(19) United States
(12) Patent Application Publication
(10) Pub. No.: US 2018/0184680 A1
(43) Pub. Date: Jul. 5, 2018

(54) LONG-LASTING COOLING FORMULATIONS

(71) Applicant: WM. WRIGLEY JR. COMPANY, Chicago, IL (US)

(72) Inventors: Minmin TIAN, Chicago, IL (US); Lisa TRAN, Chicago, IL (US); Armando CASTRO, Chicago, IL (US); Sonya JOHNSON, Chicago, IL (US); Olivier LESCOP, Chicago, IL (US)

(21) Appl. No.: 15/740,683

(22) PCT Filed: Jun. 30, 2016
(86) PCT No.: PCT/US2016/040522

§ 371 Date: Dec. 28, 2017

Related U.S. Application Data
(60) Provisional application No. 62/212,519, filed on Aug. 31, 2015.
(60) Provisional application No. 62/187,129, filed on Jun. 30, 2015.

(51) Int. Cl. A23G 4/06

(52) U.S. Cl. CPC A23G 4/068; A23G 2220/20; A23V 2200/221; A23V 2200/15; A23V 2002/00

(57) ABSTRACT

The present application discloses long-lasting cooling formulations which comprise at least one cooling agent and are suitable for use in confectionery products. In certain, non-limiting embodiments of the disclosed formulations, the cooling agent is N,2,3-Trimethyl-2-isopropylbutamide (WS-23), (1R,2S,5R)-N-(4-Methoxyphenyl)-5-methyl-2-(1-methylethyl)cyclohexanecarboxamide (WS-12), N-(Ethoxycarbonylmethyl)-3-p-menthanecarboxamide (WS-5), or mixtures thereof. In certain embodiments, the disclosed formulations provide enhanced cooling attributes for mints and chewing gum.

### CROSS-REFERENCE TO RELATED APPLICATIONS

This application claims priority to U.S. Provisional Application No. 62/187,129, filed Jun. 30, 2015, and U.S. Provisional Application No. 62/212,519, filed Aug. 31, 2015, which are incorporated by reference herein in their entireties.

### FIELD

The presently disclosed subject matter relates to long-lasting cooling formulations, particularly for use in confectionery products. Specifically, the present disclosure is directed to flavor compositions that include one or more cooling compounds. The flavor compositions can include combinations of compounds that can be used to enhance a cooling attribute, such as perceived duration of cooling, of various delivery system formats, such as mints, gum, and the like.

### BACKGROUND

Confectionery products are known to have a variety of attributes, with cooling attributes of particular interest. Various confectionery products are formulated to impart long-lasting cooling attributes with the use of various cooling agents. Such products include mints or gums, among others.

Efforts have been directed at perfecting the use of cooling agents within chewing gum and other confectionery formulations to enhance flavor compositions and to control their release to augment and prolong the flavor of chewing gum or other confectionery. U.S. Pat. No. 6,627,233 (hereby incorporated herein by reference) discloses a number of physiological cooling agents and combinations of physiological cooling agents, including N-2,3-trimethyl-2-isopropyl butanamide (called WS-23), as well as their use in chewing gum.

Cooling, in particular, is a desirable consumer sensory attribute as it is correlated with breath freshening effectiveness, lasting flavor, and the increased overall liking of a product. At present, there is still a need for alternative novel cooling formulations for confectionery products with improved flavor, long-lasting cooling effects, and overall quality. The presently disclosed subject matter addresses this need as discussed in detail below.

### SUMMARY OF THE INVENTION

The presently disclosed subject matter is directed to a flavor composition comprising a compound selected from the group consisting of

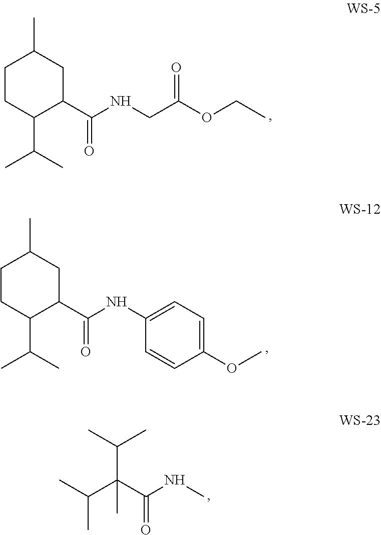

and combinations thereof.

In particular embodiments, the flavor composition comprises compounds

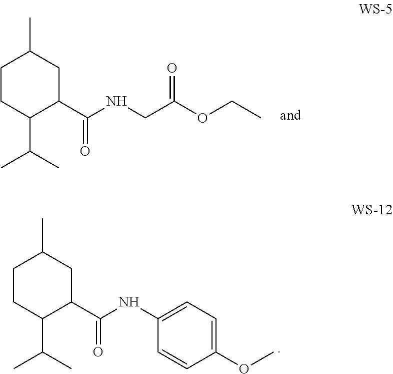 [SMILES: CCOC(=O)CNC(=O)C1CC(C)CCC1C(C)C ; COc1ccc(NC(=O)C2CC(C)CCC2C(C)C)cc1]

In certain embodiments, the presently disclosed subject matter provides for a food product comprising the subject flavor compositions. In particular embodiments, the flavor composition is present at a concentration of from about 100 to about 1000 ppm. In other embodiments, the flavor composition is present at a concentration of from about 0.01% to about 6% weight/weight of the food product.

In particular embodiments, the food product is a compressed mint. In other embodiments, the food product is chewing gum.

In certain embodiments, the flavor composition includes compounds present in approximately a 1:1 ratio by weight percent of the flavor composition. In certain embodiments, the flavor composition includes WS-5 and WS-12 present in approximately from about a 1:10 to about a 10:1 ratio by weight percent of the flavor composition. In specific embodiments, the flavor composition includes WS-5 and WS-12 present in approximately a 1:1 ratio by weight percent of the flavor composition.

The foregoing has outlined broadly the features and technical advantages of the present application in order that the detailed description that follows may be better understood. Additional features and advantages of the application will be described hereinafter, which form the subject of the claims of the application. It should be appreciated by those skilled in the art that the conception and specific embodiment disclosed may be readily utilized as a basis for modifying or designing other structures for carrying out the same purposes of the present application. It should also be realized by those skilled in the art that such equivalent constructions do not depart from the spirit and scope of the application as set forth in the appended claims. The novel features which are believed to be characteristic of the application, both as to its organization and method of operation, together with further objects and advantages will be better understood from the following description.

### BRIEF DESCRIPTION OF THE DRAWINGS

FIGS. 1a-1c provide graphical representations of attributes of specific compounds alone or in combination as provided in the disclosed subject matter. Specifically, FIG. 1a depicts the cooling intensity against time of WS23, WS12, WS5, and combinations thereof, in compressed mints. FIG. 1b depicts the flavor intensity over time of WS23, WS12, WS5, and combinations thereof, in compressed mints. FIG. 1c depicts the level of bitterness over time of WS23, WS12, WS5, and combinations thereof, in compressed mints. In each graphic, time is provided in minutes (x-axis), and the attribute is evaluated on a 9-point scale, with 0 being the lowest and 9 being the highest. Each attribute is plotted accordingly (y-axis).

FIGS. 2a-2c provide graphical representations of descriptive analysis of specific compounds alone or in combination as provided in the disclosed subject matter. Specifically, FIG. 2a depicts the level of nasal cooling, oral cooling and thymol flavor against time of WS-23, WS-12, WS-5, and combinations thereof, when incorporated in a compressed mint. FIG. 2b depicts the level of tongue numbing, oral burn, throat burn and tongue burn against time of WS-23, WS-12, WS-5, and combinations thereof, in a compressed mint. FIG. 2c depicts the level of astringent, bitter, and menthol attributes over time of WS-23, WS-12, WS-5, and combinations thereof, in a compressed mint. In each graphic, time is provided in minutes (x-axis), and the attribute is evaluated on a 9-point scale, with 0 being the lowest and 9 being the highest. Each attribute is plotted accordingly (y-axis).

### DETAILED DESCRIPTION

As noted above, to date, there remains a need in the art for flavor compositions that provide long-lasting cooling attributes to various confectionery products. The presently disclosed subject matter addresses this need through the use of one or more cooling compounds that provide breath freshening effectiveness, prolonged flavor, and an increased overall liking and quality in a product.

### 1. Definitions

The terms used in this specification generally have their ordinary meanings in the art, within the context of this disclosed subject matter and in the specific context where each term is used. Certain terms are discussed below, or elsewhere in the specification, to provide additional guidance to the practitioner in describing the compositions and methods of the disclosed subject matter and how to make and use them.

As used herein, the use of the word “a” or “an” when used in conjunction with the term “comprising” in the claims and/or the specification may mean “one,” but it is also consistent with the meaning of “one or more,” “at least one,” and “one or more than one.” Still further, the terms “having,” “including,” “containing” and “comprising” are interchangeable and one of skill in the art is cognizant that these terms are open ended terms.

The term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, preferably up to 10%, more preferably up to 5%, and more preferably still up to 1% of a given value.

Unless otherwise specified, all percentages used herein are weight percentages.

As used herein, “ppm” means parts-per-million and is a weight relative parameter. A part-per-million is a microgram per gram, such that a component that is present at 10 ppm is present at 10 micrograms of the specific component per 1 gram of the aggregate mixture.

As used herein, “admixing,” refers to the process where the cooling formulation is mixed with or added to the completed product or mixed with some or all of the components of the product during product formation or some combination of these steps. When used in the context of admixing, the term “product” refers to the product or any of its components. This admixing step can include a process selected from the step of adding the cooling formulation to the product, spraying the cooling formulation on the product, coating the cooling formulation on the product, suspending the cooling formulation in the product, painting the cooling formulation on the product, pasting the cooling formulation on the product, encapsulating the product with the cooling formulation, mixing the cooling formulation with the product and any combination thereof. The cooling formulation can be a liquid, dry powder, spray, paste, suspension and any combination thereof.

As used herein, the term “chewing gum” refers to a flavored substance intended for chewing. The term as used herein also includes bubble gum and confectionery products containing chewing gum. In certain embodiments, chewing gum forms include, but are not limited to, tablets, sticks, solid balls, hollow balls, cut and wrap, and pellets or pillows. As used herein, chewing gum contains a water insoluble base portion and a water-soluble bulk portion.

As used herein, the term “compressed mint” refers to a hard confectionery product that requires sufficient strength to bite and/or shatter and primarily dissolves in the mouth by sucking.

As used herein, “physiological cooling agents” encompasses any number of physiological cooling agents but does not include traditional flavor-derivatives such as menthol or menthone. Preferred physiological agents provide a cooling effect without imparting perceptible flavor of their own. Several known compounds have what can be characterized as a “cooling” activity, and are referred to in the art as “physiological cooling agents.” Physiological cooling agents are perceived as cold or cool when contacted with the human body and, in particular, with the mucous membranes of the mouth, nose and throat.

As used herein, the term “breath freshening agent” means compounds or compositions that counteract malodor. Breath freshening agents include, but are not limited to, salts of zinc, salts of copper, polyphenols, mushroom extracts and mixtures thereof.

As used herein, the term “mouth odor masking flavor” means compounds or compositions that cover, mask or overpower malodor. Mouth odor masking flavors include but are not limited to cinnamon, mint, wintergreen, fruit flavors and mixtures thereof.

As used herein, the term “dental active agent” means compounds or compositions which promote oral health or deliver active ingredients to the teeth. Dental active agents include, but are not limited to, tooth whiteners, fluoride, stain removers, calcium salts, phosphate salts and mixtures thereof.

As used herein, the term “Log P value” or the “partition coefficient” is the ratio of the concentration of a specific compound in octanol to its concentration in water. In the context of physiological cooling compounds as disclosed herein, a high log P value corresponds to lower water solubility and a decreased ability for coolant release from a product, for example coolant release from a chewing gum composition. Non-limiting examples of the Log P values of cooling agents include WS-23 with a Log P value of 2.61 and menthol with a Log P value of 3.34.

As used herein, the terms “synergistic interaction” or “synergistic enhancement” refers to the surprising and unexpected effect when two chemical compounds taken together is greater than the sum of each chemical compound's separate effect at the same amount and/or level.

### 2. Cooling Formulations

The present application relates to cooling formulations that include at least one, two, three, or more cooling compounds. In certain embodiments, the cooling formulations can be used to enhance or increase the longevity of a cooling sensory attribute of an edible composition, such as chewing gum or compressed mints. In further embodiments, the cooling formulations provide an enhanced cooling sensory attribute without increasing a bitter taste or off-taste in the edible food composition. In certain embodiments, the cooling formulation comprises two or more cooling compounds that provide a greater than additive (i.e., synergistic) enhancement of a cooling sensory attribute when admixed with an edible food composition. Furthermore, when the cooling formulation comprises such combinations of cooling compounds, the admixture has a reduced bitter taste or off-taste compared to an admixture comprising the individual cooling compounds of the cooling formulation.

In other embodiments, the cooling formulations can be used to enhance or modify flavor duration, breath freshening effect and overall consumer liking scores of an edible composition. The cooling formulations can include combinations of cooling compounds, and can be added to edible compositions in various delivery system formats.

In certain non-limiting embodiments, the cooling formulation comprises the compound WS-5 (N-(Ethoxycarbonylmethyl)-3-p-menthanecarboxamide), having the following structure:

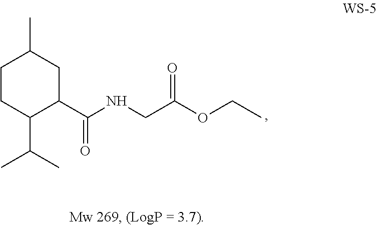 [SMILES: CCOC(=O)CNC(=O)C1CC(C)CCC1C(C)C]

The present disclosure also provides for stereoisomers of the compound WS-5.

In certain non-limiting embodiments, the cooling formulation comprises the compound WS-12 ((1R,2S,5R)-N-(4-Methoxyphenyl)-5-methyl-2-(1-methylethyl)cyclohexanecarboxamide), having the following structure:

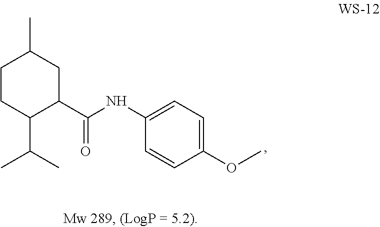 [SMILES: COc1ccc(NC(=O)C2CC(C)CCC2C(C)C)cc1]

The present disclosure also provides for stereoisomers of the compound WS-12.

In certain non-limiting embodiments, the cooling formulation comprises the compound WS-23 (N,2,3-Trimethyl-2-isopropylbutamide), having the following structure:

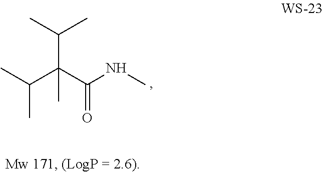

The present disclosure also provides for stereoisomers of the compound WS-23.

In one non-limiting embodiment, the cooling formulation of the presently disclosed subject matter comprises WS-5, WS-12, WS-23, or combinations thereof.

In one specific non-limiting embodiment, the cooling formulation comprises WS-5 and WS-12.

In another non-limiting embodiment, the cooling formulation comprises WS-3, WS-4, WS-14, WS-24, WS-31 or combinations thereof.

In certain embodiments, the formulation comprises compounds present in a 1:1 ratio by weight percent of the flavor composition. In certain embodiments, the formulation comprises WS-5 and WS-12 present in from about a 1:1 to about 1:10, or from about 1:1 to about 10:1, ratio by weight percent of the flavor composition. In certain embodiments, the formulation comprises WS-5 and WS-12 present in a 1:1, or 1:2, or 1:5, or 1:10, or 2:1, or 5:1, or 10:1, ratio by weight percent of the flavor composition.

In yet other non-limiting embodiments, the cooling formulations of the disclosed subject matter can further comprise one, two, three, four, five or more cooling compounds, for example, as described by U.S. Pat. No. 7,025,999; and U.S. Publication Nos. 2007/0248717, 2013/0156885, and 2005/0202118, each of which is herein incorporated by reference in its entirety.

### 3. Food Products

The cooling formulations of the presently disclosed subject matter can be used to enhance or modify a cooling sensory attribute of various edible compositions such as chewing gum and sweet goods, for example, mints and candies. In one embodiment, such enhancement is an increase in the longevity of a cooling sensory attribute that is detectable, for example, by a sensory panelist, as described herein, compared to an edible composition that does not comprise the cooling formulations of the presently disclosed subject matter. The cooling formulations can include combinations of cooling compounds, and can be added to edible compositions in various delivery system formats.

In certain embodiments of the disclosed subject matter, an edible composition can be produced that contains a sufficient amount of at least one, two, three, four, five or more cooling formulation(s), or its various subgenuses described herein, for example, a cooling compound, such as WS-5, WS-12, and/or WS-23, to produce an edible composition having the desired cooling sensory attribute.

In certain embodiments, the disclosed subject matter relates to methods for enhancing or modulating a cooling sensory attribute of an edible product comprising: a) providing at least one comestible food product, or a precursor thereof, and b) combining the comestible food product or precursor thereof with at least a cooling sensory attribute modulating amount of at least one, two, three, four, five, or more cooling formulation(s), or any of its subgenuses, for example, one, two, three, four, five or more cooling compounds, such as WS-5, WS-12, and/or WS-23, so as to form a modified edible food product.

In certain embodiments, at least a cooling sensory attribute modulating amount of one, two, three, four, five or more of the cooling formulations of the presently disclosed subject matter can be added to the edible food product, so that the cooling sensory attribute modified edible food product has an enhanced cooling sensory attribute, as compared to the edible food product prepared without the cooling formulation, as determined by human beings or animals in general, or in the case of formulation testing, as determined by a taste panel of at least one, two, three, four, five or more human taste testers, via procedures known in the art.

In certain embodiments of the presently disclosed subject matter, the cooling formulation is added to an edible food product in an amount effective to enhance a cooling sensory attribute, wherein the attribute is not associated with a bitter taste or off-taste. In one non-limiting example, admixing a cooling formulation comprising a combination of two or more cooling compounds with an edible food product provides the admixture with an enhanced cooling sensory attribute, and a reduced bitter taste or off-taste, compared to an admixture comprising an individual cooling compound of the cooling formulation.

The concentration of cooling formulation admixed with an edible food product to modulate or enhance a cooling sensory attribute of the edible food product or composition can vary dependent on variables, such as, for example, the specific type of edible composition, what cooling compounds are already present in the edible food product and the concentrations thereof, and the enhancer effect of the particular cooling formulation on such cooling compounds.

A broad range of concentrations of the cooling formulations can be employed to enhance or modify a cooling sensory attribute of an edible food product. In certain embodiments of the present application, the cooling formulation is admixed with a food product wherein the cooling formulation is present in an amount of from about 1 to about 5000 ppm, or from about 5 to about 2500 ppm, or from about 10 to about 2000 ppm, or from about 50 to about 1500 ppm, or from about 100 to about 1000 ppm, or from about 150 to about 500 ppm, or from about 200 to about 250 ppm, and values in between.

In one non-limiting embodiment, the cooling formulation is admixed with a food product wherein the cooling formulation is present in an amount of about 1000 ppm. In certain embodiments, said cooling formulation comprises the cooling compound WS-12 and/or WS-23.

In one non-limiting embodiment, the cooling formulation is admixed with a food product wherein the cooling formulation is present in an amount of about 500 ppm. In certain embodiments, said cooling formulation comprises the cooling compound WS-5 and/or WS-12.

In one non-limiting embodiment, the cooling formulation is admixed with a food product wherein the cooling formulation is present in an amount of about 750 ppm. In certain embodiments, said cooling formulation comprises the cooling compound WS-12.

In another non-limiting embodiment, the cooling formulation is admixed with a food product wherein the cooling formulation comprises the cooling compounds WS-5 and WS-12, wherein WS-5 is present in the admixture at a concentration of about 250 ppm, and wherein WS-12 is present at a concentration of about 250 ppm.

In certain embodiments of the presently disclosed subject matter, the cooling formulation is admixed with a food product wherein the cooling formulation is present in an amount of from about 0.0001 to about 10% weight/weight (w/w), or from about 0.001 to about 8% w/w, or from about 0.01 to about 6% w/w, or from about 0.025 to about 4% w/w, or from about 0.05 to about 2% w/w, or from about 0.075 to about 1% w/w, or from about 0.1 to about 0.5% w/w, and values in between.

In one non-limiting embodiment, the cooling formulation is admixed with a food product wherein the cooling formulation is present in an amount of about 0.1% w/w. In certain embodiments, said cooling formulation comprises the cooling compound WS-12 and/or WS-23.

In one non-limiting embodiment, the cooling formulation is admixed with a food product wherein the cooling formulation is present in an amount of about 0.05% w/w. In certain embodiments, said cooling formulation comprises the cooling compound WS-5 and/or WS-12.

In one non-limiting embodiment, the cooling formulation is admixed with a food product wherein the cooling formulation is present in an amount of about 0.075% w/w. In certain embodiments, said cooling formulation comprises the cooling compound WS-12.

In another non-limiting embodiment, the cooling formulation is admixed with a food product wherein the cooling formulation comprises the cooling compounds WS-5 and WS-12, wherein WS-5 is present in the admixture at a concentration of about 0.025% w/w, and wherein WS-12 is present at a concentration of about 0.025% w/w.

In certain embodiments of the presently disclosed subject matter, the cooling formulation is encapsulated prior to use in an end product. In certain embodiments, the encapsulated formulation is admixed with a food product wherein the encapsulated cooling formulation is present in an amount of from about 1 to about 5000 ppm, or from about 5 to about 2500 ppm, or from about 10 to about 2000 ppm, or from about 50 to about 1500 ppm, or from about 50 to about 1000 ppm, or from about 50 to about 500 ppm, or from about 50 to about 250 ppm, and values in between.

In certain embodiments, the cooling formulation is admixed with a food product in an amount effective to enhance a cooling sensory attribute by about 1 to about 10 fold, or from about 1.25 to about 8 fold, or from about 1.5 to about 6 fold, or from about 1.75 to about 4 fold, or from about 2 to about 2.5 fold, and values in between, compared to a cooling sensory attribute reference.

In one non-limiting embodiment, the cooling formulation comprises a combination of cooling compounds, wherein an edible food composition comprising the cooling formulation has a decreased level of oral, tongue and/or throat burn, as perceived by a sensory panelists, as described herein, compared to an admixture comprising an individual cooling compound of the cooling formulation.

In certain embodiments, the cooling formulations of the presently disclosed subject matter can be incorporated into a delivery system for use in edible compositions. For example, the cooling formulations can be delivered encapsulated or neat. Delivery systems can be liquid or solid, aqueous or non-aqueous. Delivery systems are generally adapted to suit the needs of the cooling formulation and/or the edible composition into which the cooling formulation will be incorporated.

In one embodiment, the cooling formulation can be encapsulated. Encapsulating materials and/or techniques can be selected to determine the type of modification of the cooling formulation. Encapsulating techniques include, for example, but are not limited to, spray drying, spray chilling, fluid-bed coating, and coacervation, wherein such techniques can provide partial encapsulation or full encapsulation In a specific non-limiting embodiment, the encapsulating materials and/or techniques are selected to modify the release profile of the cooling formulation from an edible food product, for example, to increase release of the cooling formation from an edible food product in the oral cavity or throat. Suitable encapsulating materials can include, but are not limited to, water-soluble sugar or sugar alcohol such as sorbitol, isomalt, dextrose, erythritol, lactitol, maltitol, mannitol, xylitol, hydrogenated corn syrup and mixtures thereof. Encapsulating materials can also include water soluble starch, modified starch, hydroxyl methyl cellulose, hydroxypropyl methylcellulose (HPMC), sodium alginate, alpha, beta and gamma cyclodextrin, polymers and combinations thereof.

### 3.1 Confectionery Products

In certain embodiments, long-lasting cooling formulations of the presently disclosed subject matter can be incorporated into a confectionery product.

In certain embodiments, long-lasting cooling formulations of the present disclosure can be incorporated into the confectionery product by admixing the inventive formulation into conventional hard and soft confections. In certain embodiments, long-lasting cooling formulations of the presently disclosed subject matter can be incorporated into confectionery products including, but not limited to, cakes, cookies, pies, candies (hard and soft), compressed mints, chewing gums, gelatins, ice creams, sorbets, jams, jellies, chocolates, fudge, fondant, liquorice, and taffy. Preferably, the long-lasting cooling formulations of the presently disclosed subject matter are incorporated into compressed mints and chewing gum.

The presently disclosed subject matter can also be incorporated into chewing gum. In certain embodiments, the chewing gum can be in the form of tablets, sticks, solid balls, hollow balls, cut and wrap, and pellets or pillows. Suitable processes for making chewing gum and additional components that may be incorporated into chewing gum are described by way of example in U.S. Pat. No. 8,557,323; U.S. Publication Nos. 2013/0156885 and U.S. 2005/0202118, each of which is incorporated by reference in its entirety herein.

The presently disclosed subject matter can be incorporated into mint confectioneries, and more particularly into compressed mint products using conventional tablet pressing procedures and equipment and suitable additional components known in the art, for example, as described by U.S. Pat. No. 8,557,323 and U.S. Pat. No. 8,431,150, each of which is herein incorporated by reference in its entirety.

Compressed mints of the presently disclosed subject matter can contain sugar or can be sugarfree. In addition to the disclosed cooling compositions, other suitable flavoring agents can be included as well as ingredients that give a tingling sensation. In the case of products with multiple layers, each layer may have different flavoring agents or levels. In one embodiment, the compressed mint can comprise a coating layer covering at least a portion of the product. In that case, the coating layer can contain flavoring agents at a level higher than any flavoring agents in the remainder of the product.

The compressed mints can include one or more of the following: anti-microbial agents; physiological cooling agents; breath freshening agents; breath freshening and mouth odor masking flavors; dental active agents; and combinations thereof.

Anti-microbial agents include but are not limited to cardamom oil, magnolia bark extract, cranberry, geraniol, cinnamaldehyde, peppermint, triclosan, chlorhexidine, cetyl pyridinium chloride (CPC) and mixtures thereof.

Physiological cooling agents include menthol N-2,3-trimethyl-2-isopropyl butanamide, 3-1-menthoxypropane-1,2-diol, N-ethyl-p-menthane-3-carboxamide, menthane ketals, menthyl succinate, isopulegol, menthyl glutarate, and mixtures thereof.

Breath freshening agents include but are not limited to salts of zinc, salts of copper, polyphenols, mushroom extracts and mixtures thereof.

Breath freshening and mouth odor masking flavors include but are not limited to cinnamon, mint, wintergreen, fruit flavors and mixtures thereof.

Dental active agents include but are not limited to tooth whiteners, fluoride, stain removers, calcium salts, phosphate salts and mixtures thereof.

In certain embodiments, the compressed tablet further contains one or more additional compounds including but not limited to sorbitol (e.g., from about 90 to about 99% w/w), acesulfame K (e.g., from about 0.05 to about 0.5% w/w), sucralose (e.g., from about 0.05 to about 0.5% w/w), magnesium stearate (e.g., from about 0.5 to about 2% w/w), Neobee oil (e.g., from about 1 to about 2% w/w), peppermint oil (e.g., from about 0.5 to about 2% w/w), and combinations thereof.

### 3.1.2 Chewing Gum

The presently disclosed subject matter can be incorporated into chewing gum using conventional procedures and equipment and suitable additional components known in the art, for example, as described by U.S. Publication Nos. 2013/0156885 and U.S. 2005/0202118, each of which is herein incorporated by reference in its entirety. In certain embodiments, the presently disclosed subject matter is encapsulated before being incorporated into chewing gum.

### 3.1.2.1 Compositions

A chewing gum center composition or other chewing gum compositions can contain a chewable gum base portion, which is essentially free of water and is water-insoluble, a water-soluble bulk portion and flavors which can be water insoluble. The water-soluble portion can dissipate with a portion of the flavor over a period of time during chewing. The gum base portion is retained in the mouth throughout the chew.

In certain embodiments, the insoluble gum base comprises elastomers, elastomer solvents, plasticizers, waxes, emulsifiers and/or inorganic fillers. In certain embodiments, the insoluble gum base can comprise elastomers, elastomer solvents, plasticizers, waxes, emulsifiers and/or inorganic fillers. Plastic polymers, such as polyvinyl acetate, which can behave as plasticizers, can also be included. In certain embodiments, plastic polymers can include but are not limited to, polyvinyl laureate, polyvinyl alcohol and polyvinyl pyrrolidone. Non-limiting examples of elastomers can include polyisobutylene, butyl rubber, (isobutylene-isoprene copolymer) and styrene butadiene rubber, as well as natural latexes such as chicle. In certain embodiments, elastomer solvents can include resins such as terpene resins. In certain embodiments, the plasticizers are fats and oils, including but not limited to, tallow, hydrogenated and partially hydrogenated vegetable oils, and cocoa butter. In certain embodiments, the waxes include, but are not limited to, paraffin, microcrystalline and natural waxes such as beeswax and carnauba.

In certain embodiments, the chewing gum further contains one or more flavor components that are derived from artificial or natural sources or combinations thereof. In certain embodiments, the chewing gum can contain sugar, or may be sugar-free. In certain embodiments, the chewing gum can comprise high potency sweeteners including, but not limited to, synthetic substances, saccharin, thaumatin, alitame, saccharin salts, aspartame, sucralose, stevia, and acesulfame.

In certain embodiments, the chewing gum further contains one more coloring agents. In certain embodiments, the coloring agents can be food quality dyes.

In certain embodiments, the one or more physiological cooling agents added to the chewing gum formulation have a Log P value of greater than 3. For example, non-limiting examples of physiological cooling agents with Log P greater than 3 and less than 8, including WS-3, WS-5, WS-14, and WS-12.

In certain embodiments, the insoluble gum base constitutes between about 5% to about 95% by weight of the gum. In certain embodiments, the insoluble gum base comprises between about 10% and about 50% by weight of the gum or about 20% to about 35% by weight of the gum.

In certain embodiments, the high potency sweetener can comprise from about 0.02% to about 0.3%, or from about 0.05% to about 0.15% by weight of the chewing gum formulation.

In certain embodiments, the flavor can be added to the chewing gum formula in an amount such that it will contain from about 0.1% to about 10% flavor, from about 0.2% to about 4.0% flavor, or from about 0.5% to about 2% flavor.

### 3.1.2.2 Methods of Making

Physiological cooling agents generally release slowly from chewing gum during mastication because of their low solubility in water. In certain embodiments, the chewing gum formation process can include modification of one or more physiological cooling agents by encapsulation. In certain embodiments, encapsulation modifies the release of physiological cooling compounds from the chewing gum by modifying the solubility or dissolution rate. Any standard technique which gives partial or full encapsulation of the combination of physiological cooling agents can be used. In certain embodiments of the presently disclosed subject matter, encapsulation techniques include, but are not limited to, spray drying, spray chilling, fluid-bed coating, and coacervation. In certain embodiments, encapsulation techniques that give partial encapsulation or full encapsulation can be used.

In certain embodiments, suitable encapsulating materials can include, but are not limited to, water-soluble sugar or sugar alcohol such as sorbitol, isomalt, dextrose, erythritol, lactitol, maltitol, mannitol, xylitol, hydrogenated corn syrup and mixtures thereof. In certain embodiments, encapsulating materials can also include water soluble starch, modified starch, hydroxyl methyl cellulose, hydroxypropyl methylcellulose (HPMC), sodium alginate, alpha, beta and gamma cyclodextrin, polymers and combinations thereof. In certain embodiments, the coating compositions can be susceptible to water permeation to various degrees. In certain embodiments, the coating composition is a food grade material.

In one non-limiting example, encapsulation can be performed as follows: mixing an encapsulating material (for example, isomalt) with deionized water, heating the mixture to boil off the water and cooling The physiological cooling agent can then be added to the isomalt melt, mixed well, and cooled to room temperature. The solidified mixture can then be ground to a specific particle size. The encapsulated physiological cooling agent product can then be added to a typical chewing gum.

In certain embodiments, the encapsulated material can be agglomerated to obtain an encapsulated/agglomerated product that can give a delayed release of the physiological cooling agents from the chewing gum.

In certain embodiments, the encapsulated cooling agent can be combined with a non-encapsulated cooling agent before additional to a chewing gum composition. For example, encapsulated WS-12 can be mixing with non-encapsulated WS-5 and the mixture can be added to a chewing gum composition,

In certain embodiments, the encapsulating material on the physiological cooling agents controls the length of time and the amount of release from chewing gum. In certain embodiments, up to about 10%, up to about 15%, up to about 20%, or up to about 25% of the one or more physiological cooling agents are released from the chewing gum during mastication. In certain embodiments, at least about 20%, at least about 25%, or at least about 30%, of the one or more physiological cooling agents are released from the chewing gum during mastication.

In certain embodiments, the encapsulant can be a minimum of about 1%, a minimum of about 30%, a minimum of about 40% by weight of the coated cooling agents.

### EXAMPLES

The presently disclosed subject matter will be better understood by reference to the following Examples, which are provided as exemplary of the disclosed subject matter, and not by way of limitation.

### Example 1: Compressed Mints

This Example provides an evaluation of compressed mints containing the flavor compositions of the presently disclosed subject matter. These mints contained one or more cooling agent as described below.

A. Preparation of Compressed Mints

Two separate sugar-free formulations were prepared for an evaluation of cooling blends. Each formulation was prepared with a control mint (wherein the cooling agent was WS-23) and with different prospective cooling agents.

Table 1 provides a summary of different variations for Formulation 1. Specifically, the table provides six Samples with a listing of each component for each sample mint.

TABLE 1
Formulation 1 control and sample mints

| | Sample 1 | Sample 2 | Sample 3 | Sample 4 | Sample 5 | Sample 6 |
|---|---|---|---|---|---|---|
| | Control | WS5 | WS12 | WS12 | WS12 | WS5/WS12, |
| Ingredient | (WS-23) | 500 ppm | 500 ppm | 750 ppm | 1000 ppm | 250/250 ppm |
| Sorbitol | 97.61% | 97.61% | 97.61% | 97.61% | 97.61% | 97.6065% |
| High potency | 0.21% | 0.21% | 0.21% | 0.21% | 0.21% | 0.21% |
| sweetener | | | | | | |
| Magnesium | 0.967% | 0.967% | 0.967% | 0.967% | 0.967% | 0.9674% |
| stearate | | | | | | |
| Neobee oil | 1.213% | 1.213% | 1.213% | 1.213% | 1.213% | 1.2131% |
| WS-23 | 0.100% | — | — | — | — | — |
| WS-5 | — | 0.0500% | — | — | — | 0.0250% |
| WS-12 | — | — | 0.0500% | 0.075% | 0.1000% | 0.0250% |
| Total | 100.0% | 100.0% | 100.0% | 100.00% | 100.0% | 100.0% |
| Piece weight | 1.0 g | 1.0 g | 1.0 g | 1.0 g | 1.0 g | 1.0 g |

Table 2 provides a summary of different variations for Formulation 2. Specifically, the table provides four Samples with a listing of each component for each sample mint.

TABLE 2
Formulation 2 control and sample mints.

| | Sample A | Sample B | Sample C | Sample D |
|---|---|---|---|---|
| Ingredient | Control | WS23, 0.1% | WS5 | WS5/WS12 |
| | | | 500 ppm | 250/250 ppm |
| Sorbitol | 97.44% | 97.34% | 97.39% | 97.39% |
| High potency | 0.316% | 0.316% | 0.316% | 0.316% |
| sweetener | | | | |
| Magnesium | 0.968% | 0.968% | 0.968% | 0.968% |
| stearate | | | | |
| Peppermint oil | 1.214% | 1.214% | 1.214% | 1.214% |
| Colorant | 0.060% | 0.060% | 0.060% | 0.060% |
| WS-23 | — | 0.100% | — | — |
| WS-5 | — | — | 0.0500% | 0.0250% |
| WS-12 | — | — | — | 0.0250% |
| Total | 100.0% | 100.0% | 100.0% | 100.0% |
| Piece weight | 0.70 g | 0.70 g | 0.70 g | 0.70 g |

All samples were prepared in a pilot plant under good manufacture practice conditions. Samples made for consumer descriptive analysis passed a metal detector test. One sample of each mint formulation was further evaluated in both Expert Sensory Analysis (ESA) and Descriptive Analysis tests.

B. Sensory Panel Analysis and Results

ESA Panel Evaluation.

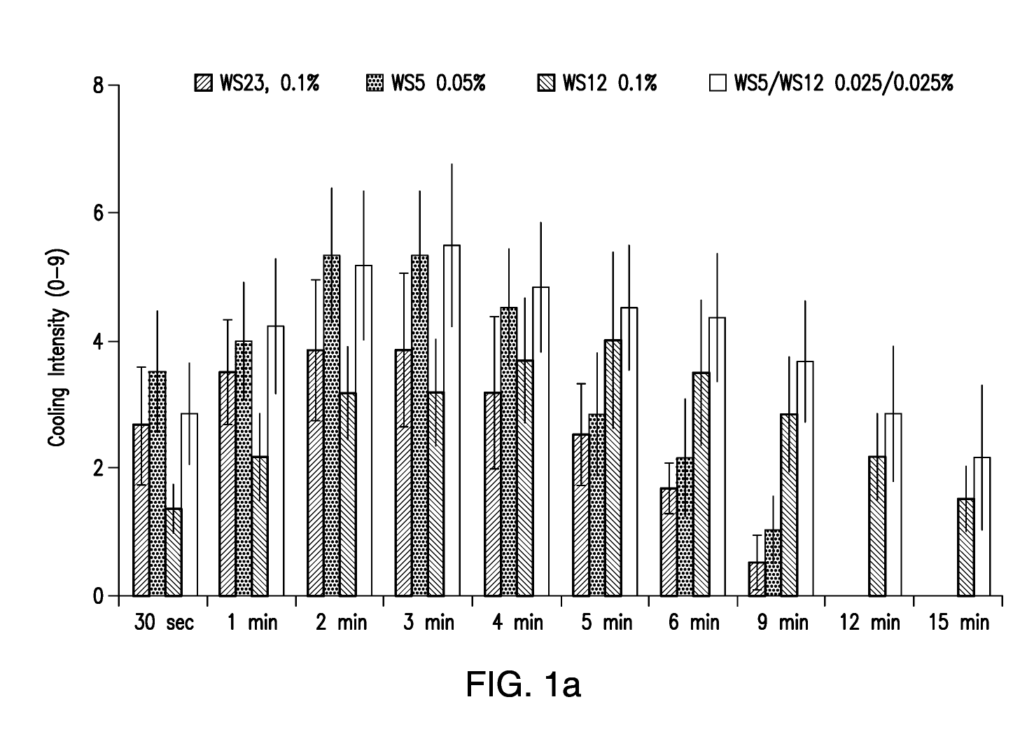

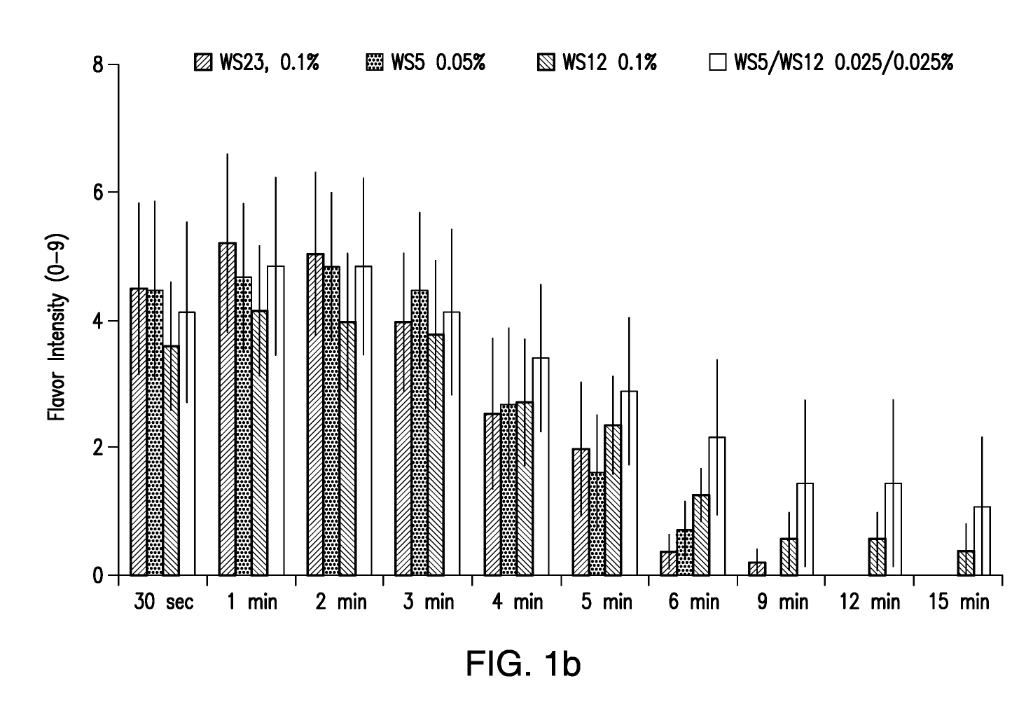

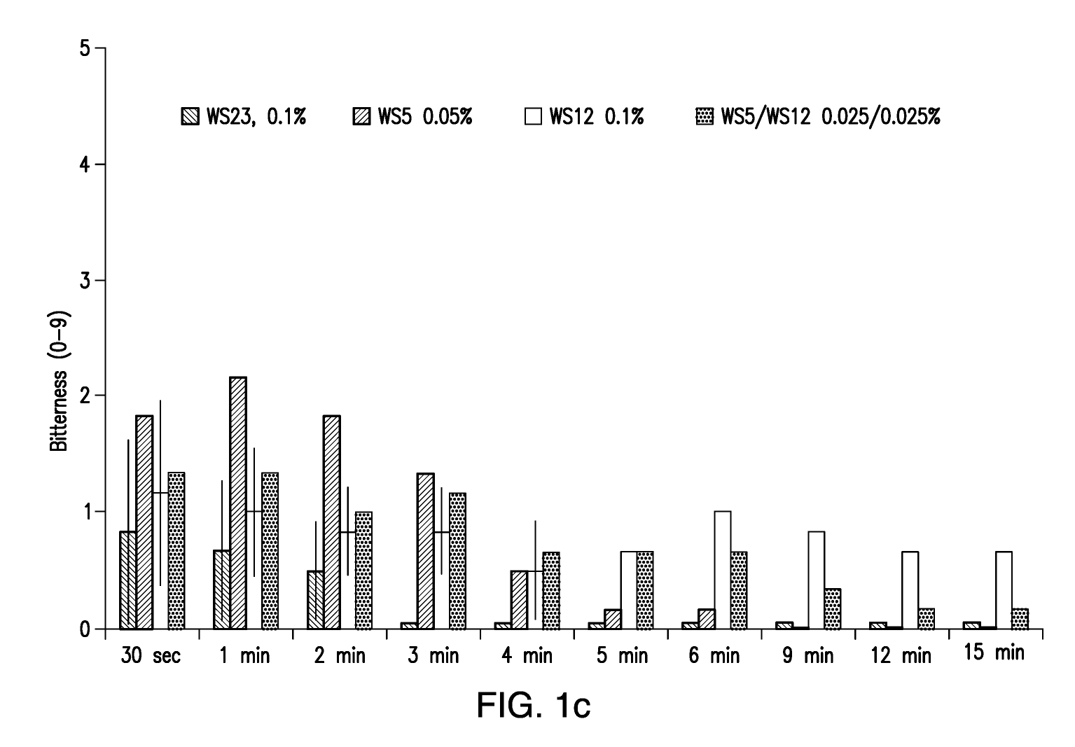

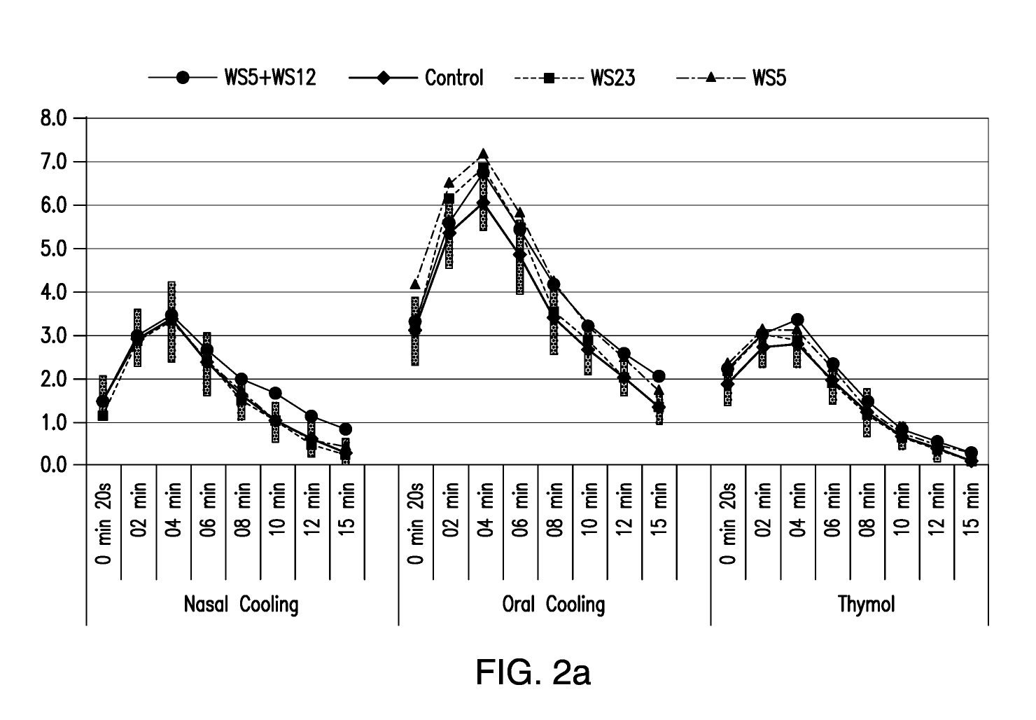

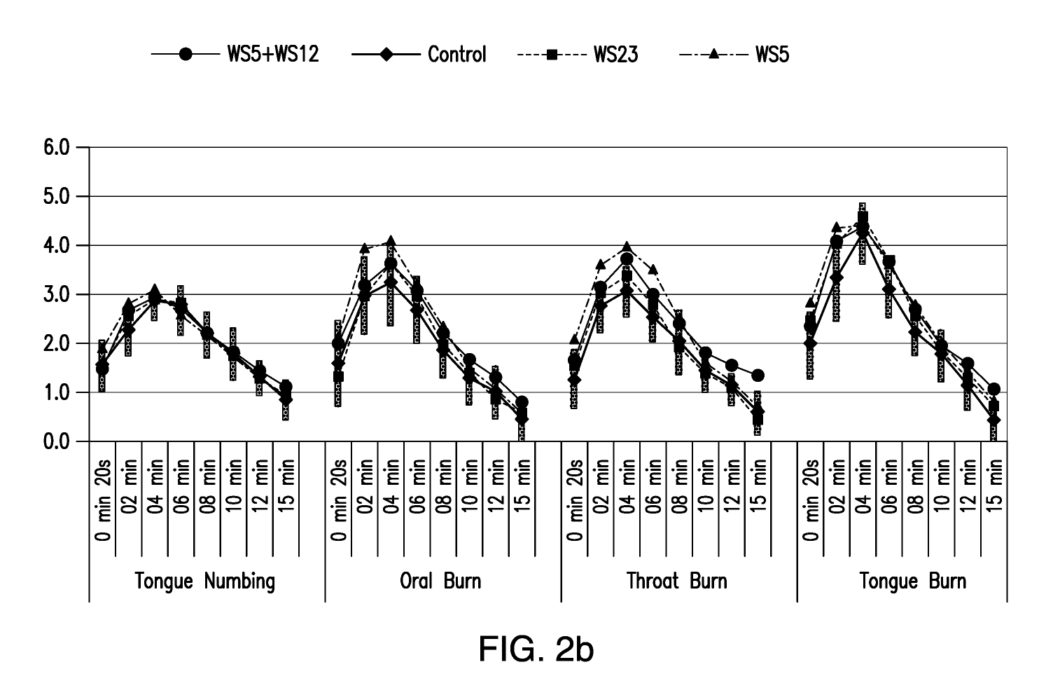

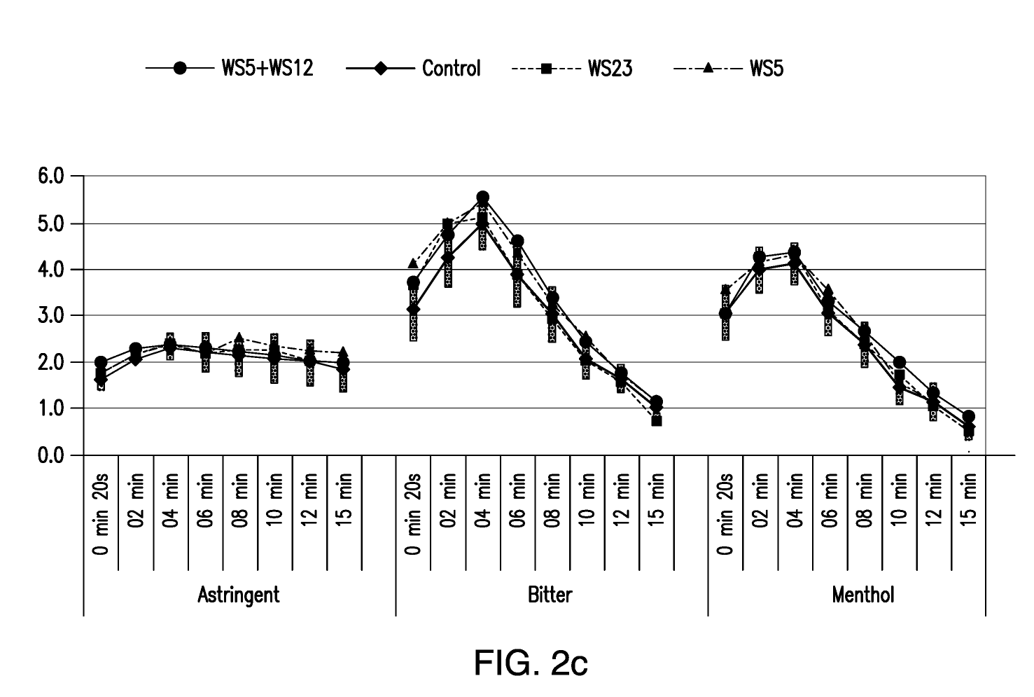

Compressed mint samples were evaluated for cooling strength, flavor strength and bitterness, or off-taste in a randomized sampling order by a 9-point scale: 0 being the lowest and 9 being the highest. Subjects were allowed to suck the compressed mint (without biting or chewing) until completely dissolved. The coolant attributes were measured at different time points up to 15 minutes. The results are summarized in FIGS. 1(a)-(c).

Descriptive Analysis Panel Study.

A Consumer-Descriptive Analysis panel study was conducted. Four mints containing various level of cooling blend were formulated at a pilot plant. During the test, each member of the descriptive panel (N=8) sucked one piece of mint until it completely dissolved. During the mint consumption, panelists evaluated various cooling attributes including oral cool and nasal cool at several specified time points. Flavor and sweetener intensity, bitterness, and off-taste were also evaluated. Panelists continued the evaluation even after mint consumption was complete, for a total of 20 minutes from the beginning of the test.

ESA Evaluation.

Compressed mints were initially formulated with a low level of WS-12 (25-100 ppm). No significant difference for cooling intensity, flavor intensity or duration of cooling versus the control mints was observed.

The level of WS-12 was increased to levels from 250 to 1000 ppm (0.025%-0.1% w/w) and additional ESA evaluations were conducted. FIG. 1 shows the test results of a compressed mint with WS-23 (1000 ppm), WS-5 (500 ppm), WS-12 (1000 ppm) and a combination of WS-5 and WS-12 (250 ppm of each).

The compressed mint comprising WS-5 showed a strong cooling intensity upfront. In contrast, the compressed mint comprising WS-12 showed very low upfront cooling (i.e., during the first 3 minutes). Nevertheless, the compressed mint comprising WS-12 showed significant more cooling after 6 min, and provided a longer lasting cooling duration (>15 min). The combination of WS-5 and WS-12 showed strong upfront cooling (i.e., for the first 3 minutes) and significant more cooling after 6 minutes as compared to a compressed mint comprising WS-23. The effect of cooling intensity and duration also positively altered flavor intensity.

WS-12 mints tasted significantly bitter and/or with a significant off-taste compared to WS-23 mints after 3 min of consumption. The combination of WS-5 and WS-12 had no significant impact on bitterness and off taste of the compressed mint. However, the combination of WS-12 and WS-5 at low level showed less bitterness/off-taste compared to WS-12 alone after 6 minutes.

Descriptive Analysis Study of Coolant Mints.

Oral Cooling.

All test coolants led to an increase in oral cooling compared to control but not all are significantly higher. The formulation comprising WS-5 and the combination of WS-5 and WS-12 was significant and had higher oral cooling during the 15 minutes. The formulation comprising WS-23 presented a superior oral cooling in first 4 minutes but then lost cooling strength and became similar to the control. The formulation comprising WS-5 is a good candidate to provide more oral cooling. For, the formulation of WS-5 combined with WS-12, the effect still remains strong.

Nasal Cooling.

Nasal cooling was the same for all samples and not different from control during the first 8 minutes. After that point, the formulation comprising WS-5 and WS-12 provided more nasal cooling. WS-12 could be at the origin of that increase in the second half of the evaluation time.

Tongue Numbing.

No significant differences were found between the tested samples.

Tongue Burn.

Differences were found within the first two minutes of sucking on the mint. The formulation comprising WS-5 presented higher tongue burn at 20 seconds and 2 minutes. Post consumption, tongue burn remained higher, but not significantly so until 15 minutes where samples The combination of WS-5 and WS-12, as well as WS-5 alone presented an increase in tongue burn.

Oral Burn.

All test samples were comparable to the control. However, the sample comprising WS-5 showed a significant increase in oral burn between 2 and 4 minutes.

Throat Burn.

Throat burn presented the biggest differences compared to control. Those differences occurred in a time window between 2 and 6 minutes where the sample comprising WS-5 and the sample comprising WS-5 and WS-12 presented significant increase in throat burn compared to control. Also, after 10 minutes, for the sample comprising both WS-5 and WS-12, throat burn was sustained even longer.

Bitter.

Bitterness of all test samples was significantly higher while sucking on the mint, and showed no difference post consumption. The combination of WS-5 and WS-12 at low levels in the sample showed less bitterness and off-taste versus WS-12 alone in the sample after 6 minutes. The sample comprising WS-12 showed tastes significantly bitter and/or with a significant off-taste as compared to the sample comprising WS-23 after 3 minutes of consumption. Other aromatic and basic taste attributes (such as overall flavor, peppermint intensity, menthol, sweetness, astringency) were not impacted by any of the test coolants.

WS-5 is a good coolant candidate as it provides oral cooling that is sustained up to 10 minutes after consumption. Like WS-5, the combination of WS-5 and WS-12 is also a good cooling candidate. Regarding most attributes, WS-23 was similar to control.

### Example 2: Chewing Gum

This Example provides an evaluation of chewing gum containing the flavor compositions of the presently disclosed subject matter. The gum compositions contain one or more cooling agents as described below.

A. Preparation of Chewing Gum

Sample A was a chewing gum prepared without encapsulation. Sample B was a chewing gum prepared with encapsulation of physiological cooling agents as follows.

SAMPLE A.

WS-12 (Log P=5.21) was added directly to a typical chewing gum formula. The formulation was mixed, sheeted and cut into pieces.

SAMPLE B.

200 grams (g) of isomalt was mixed with 40 g of deionized water. The mixture was heated to 155° C. to boil off the water and subsequently cooled. 3.0 g of WS-12 was slowly added to the isomalt melt, mixed well, and cooled to room temperature. The solidified isomalt/WS-12 mixture was grinded to 16-20 mesh particle size. The encapsulated WS-12 was then added to a typical chewing gum base. It was mixed, sheeted and cut into tab form.

B. Analysis and Results

Samples A and B were chewed by 6 volunteers. Gum cuds were collected and analyzed by gas chromatography-mass spectrometry (GC-MS). The results are summarized in Table 3.

TABLE 3
Release of WS-12 from Sample A and Sample B.

| | |
|---|---|
| Sample A | Sample B |

| | |
|---|---|
| Chewing time | 20 min |

| | | |
|---|---|---|
| Total Release | 0.16% | 27.8% ± 4.2% |

There was little to no appreciable release of WS-12 from chewing gum Sample A, over 20 minutes of chewing. WS-12 has a high log P which typically means lower water solubility and a decreased ability for coolant release from chewing gum base. Therefore adding WS-12 directly to chewing gum formula has limited cooling effect.

Compared to the direct addition of WS-12 to chewing gum in Sample A, there was an appreciable release of isomalt-encapsulated WS-12 from the encapsulated chewing gum of Sample B. Therefore, adding isomalt-encapsulated WS-12 to chewing gum formula will substantially enhance the ability of WS-12 to be released from the chewing gum matrix, despite having a high Log P value. Increased release of WS-12 allows the cooling agent to better perform its function of providing long lasting cooling.

WS-12 releases <5% over 20 minutes in conventional gum, and when encapsulated, releases up to 30% over a 20 minute chew from a similar gum when used in the encapsulated form.

Although the presently disclosed subject matter and its advantages have been described in detail, it should be understood that various changes, substitutions and alterations can be made herein without departing from the spirit and scope of the disclosed subject matter as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the presently disclosed subject matter, processes, machines, manufacture, compositions of matter, means, methods, or steps, presently existing or later to be developed that perform substantially the same function or achieve substantially the same result as the corresponding embodiments described herein may be utilized according to the presently disclosed subject matter. Accordingly, the appended claims are intended to include within their scope such processes, machines, manufacture, compositions of matter, means, methods, or steps.

Patents, patent applications publications product descriptions, and protocols are cited throughout this application the disclosures of which are incorporated herein by reference in their entireties for all purposes.

What is claimed is:

1. A flavor composition comprising a compound selected from the group consisting of 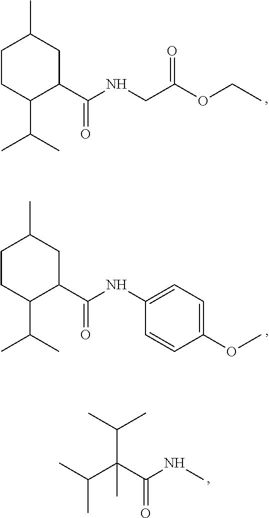
and combinations thereof.

2. The flavor composition of claim 1, wherein the flavor composition comprises compounds

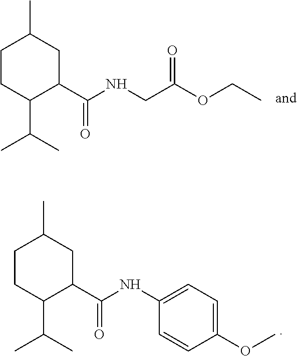 [SMILES: CCOC(=O)CNC(=O)C1CC(C)CCC1C(C)C ; COc1ccc(NC(=O)C2CC(C)CCC2C(C)C)cc1]

3. A food product comprising the flavor composition of any one of claims 1 and 2.

4. The food product of claim 3, wherein the flavor composition is present at a concentration of from about 100 to about 1000 ppm.

5. The food product of claim 3, wherein the flavor composition is present at a concentration of from about 0.01 to about 6% weight/weight of the food product.

6. The food product of any one of claims 3-5, wherein the food product is a compressed mint.

7. The food product of any one of claims 3-5, wherein the food product is chewing gum.

8. The food product of claim 7, wherein the flavor composition is encapsulated.

9. The flavor composition of claim 1, wherein the compound(s) are present in a 1:1 ratio by weight percent of the flavor composition.

10. The flavor composition of claim 2, wherein the compounds are present in a ratio of from about 1:10 to about 10:1 by weight percent of the flavor composition.

11. The flavor composition of claim 2, wherein the compounds are present in a ratio of about 1:1 by weight percent of the flavor composition.
